(19) United States
(12) Patent Application Publication
(10) Pub. No.: US 2008/0039753 A1
(43) Pub. Date: Feb. 14, 2008

(54) Portable Apparatus for Hydrotherapy, Fluid-Therapy, Thermotherapy, Homotherapy with or without presence of topical medication in a medium

(76) Inventors: Mehdi Zomorodian, Vienna, VA (US); Michael M. Mojaver, Pasadena, CA (US)

Correspondence Address: Michael M. Mojaver;Mehdi Zomorodian, 1105 Pine Bluff Drive, Pasadena, CA, 91107-1753, US

(21) Appl. No.: 11/463,732

(22) Filed: Aug. 10, 2006

(51) Int. Cl. A61H 7/00; A61H 19/00

(52) U.S. Cl. 601/148

(57) ABSTRACT

An apparatus and/or appliance to provide hydrotherapy coupled with thermotherapy, massaging, and/or application of topical medication or holistic natural remedies for one's extremities.

### SUMMARY

A portable counter top or floor mount aquatic apparatus for use as a hydrotherapy appliance by a person for post operative, post injury, post sport event muscular, nervous system, and/or skeletal therapy and rehabilitation as well as pre-conditioning and toning of the muscles, nerves, joints, and bones. The invention has far reaching use and utility application that includes specific utilization by athletes, non-athletes, male or female individual of all age groups. The claimed invention is designed as to enable a person's extremities (1-wrists and fingers, 2-elbows, 3-ankles, feet and toes, and 4-knees) be submerged in the fluid content of the said invention and still enjoy free movement. Users of the invention; boxers, tennis players, etc., young individuals with carpal tunnel, a middle age man with twisted ankle, an sports enthusiast with a knee replacement surgery, an elderly person with stiff joints and arthritis could all physically move and manipulate their body extremities while within the said invention fluid content so as to further enhance their natural exercising abilities with that of the said invention massaging action. The buoyancy in the fluid content eases pain caused by movement while the massage therapy enhances and stimulates blood circulation and expedites body's natural and inherent healing power.

The fluid content within said invented apparatus has a hydrotherapy jet system, which together with the venturi action of micro/macro injector jets aerate the fluid stream ejected through jet nozzles whereby enhancing the massaging effect of said invention. The fluid embodied in the vessel is temperature controlled and the said invention provides for the ability to raise temperature to a safe 104° F. Invention provides multiple claims for different utilities and as such the injector jets can be spinal, multi-directional, and adjustable with variable direction and/or any combination thereof. The number of such injector jets and/or their type has no bearing on the therapeutic effects of said invention.

The invention intends to provide a solution on a portable apparatus and as such there are four claims against the size and typical utilization of the apparatus. One configuration is the smaller one whereby the user can put one hand and wrist or one foot and ankle at a time. The second claim is against the larger apparatus which, although heavier, is still portable and provides for insertion of both wrist and hands or both ankles and feet, one elbow at a time, or one knee at a time. Third claim is for multi-user application. And fourth claim is an enhancement of any and all previous three claims with a use of three way drain valve to drain the contentment and provide for cleaning and maintenance.

### BACKGROUND AND BRIEF DESCRIPTION OF THE INVENTION

The present invention relates to hydrotherapy and massaging of one's extremities via use of buoyancy of fluids such as water, heavy water, and light mineral oils. The use of said fluids as a media are essential to the invention, however, the fluids may be used in ambient temperature or elevated temperature with presence or absence of topical prescribed medication or Homotherapy and holistic natural herbs known to heal certain joint, bone, muscle, ligament, tendons pain and/or stiffness.
1) Rheumatoid arthritis (RA); is a systemic inflammatory disease that affects the joint linings and destroys bones, tissues, and joints. Rheumatoid arthritis often starts in smaller joints, like those found in the hand and wrist, and is symmetrical, meaning that it usually affects the same joint on both sides of the body.
2) Osteoarthritis (OA); is a progressive condition that destroys the smooth articular cartilage covering the ends of bones. The bare bones rub against each other, resulting in pain, stiffness and weakness. OA can develop due to normal “wear-and-tear” on the wrist or as a result of a traumatic injury to the forearm, wrist or ligaments.
3) Carpal Tunnel Syndrome; is a common source of hand numbness and pain. It is more common in women than men and affects up to 10 percent of the population. It is caused by increased pressure on a nerve entering the hand through the confined space of the carpal tunnel. The median nerve travels from the forearm into hand through a tunnel in the wrist. The bottom and sides of this tunnel are formed by wrist bones and the top of the tunnel is covered by a strong band of connective tissue called a ligament.
4) Work, leisure, and/or sport related accidents often affect one's extremities such as;
   a. Wrist, hand, and fingers,
   b. Elbows,
   c. Ankles, feet, and toes, and/or
   d. Knees
5) The same extremities;
   a. Wrist, hand, and fingers,
   b. Elbows,
   c. Ankles, feet, and toes, and/or
   d. Knees
   are often subject to pre-conditioning, strengthening and toning by athletes in great majority of sport fields.

The present invention rides on;
1) fluid buoyancy to reduce the efforts needed to manipulate and move the extremities thereby reducing pain and/or resistance,
2) the pulsating, rotating, and circular motion of any of the said media,
3) increased heat relative to the ambient temperature that stimulates blood circulation and enhances body's natural healing power, and
4) the users' exercising of their extremities in a free fashion.

Current spas and bath tubs and other messaging apparatus and appliances available lack 3 of the aforementioned underlying factors. Therefore a need for the present invention exists among all age groups, genders, athlete, or non-athlete.

### DETAILED DESCRIPTION OF INVENTION

The present invention consists of five major components as such;
1. The vessel containing the medium with a membrane orifice to insert one's extremities
2. The control panel orchestrating the functions and turning the apparatus on and off
3. Micro Jet Injectors that provide the massage therapy and the plumbing form fluid and air attached thereof
4. Circulating pump
5. Heating mechanism for thermotherapy

When and how a need for the present invention is sensed by general public?

Signs and symptoms that can alert a person and trigger the need for the present invention may include the following.

OA of the wrist, ankle, and/or knee joint manifests with swelling, pain, limited motion and weakness. These symptoms are usually limited to the wrist, ankle, and/or knee joint itself.

RA of the wrist, ankle, and/or knee joint usually manifests with swelling, tenderness, limited motion and decreased grip strength or mobility. In addition, hand and foot functions may be impaired and there may be pain in the knuckle joints (metacarpophalangeal or MP joints).

Joint swelling may also put pressure on the nerves that travel through the wrist. This can cause a lesion to develop (compression neuropathy) or lead to carpal tunnel syndrome.

Carpal Tunnel Syndrome usually begins gradually without a specific injury. Numbness, tingling and pain in the hand are common. One may experience an electric-like shocking feeling. The thumb side of the hand is usually most involved. Symptoms at night are common and may awaken one from sleep. During the day symptoms frequently occur with holding a phone, reading or driving. Symptoms may occur at any time. Moving or shaking the hands often helps decrease symptoms. Sometimes strange feelings and pain will travel up the arm. Initially symptoms come and go, but over time they may become constant. A feeling of clumsiness or weakness can make delicate motions like buttoning buttons difficult and may cause the inflicted person to drop things. If the condition is very severe, muscles in the palm may become visibly wasted.

And of course, leisure, sport, or work related injuries happen that can significantly affect one's quality of life.

In general, early treatment is non-surgical and designed to help relieve pain and swelling. Several therapies can be used to treat RA, OA, and/or Carpal Tunnel Syndrome including:
Modifying your activities. (Present invention intends to do this)
Immobilizing the wrist for a short time in a splint. (Present invention intends to eliminate such need)
Taking anti-inflammatory medications such as aspirin or ibuprofen.
Applying topical remedies. (Present invention intends to assist with this)
Following a prescribed exercise program. (Present invention intends to do this)
Getting a steroid injection into the joint. (Present invention intends to eliminate such need)

Physician may prescribe other therapies, depending on the type of arthritis you have. For example, additional therapies for patients with rheumatoid arthritis include antimalarial drugs, antimetabolites, gold, immunosuppresive drugs (both non-steroidal and corticosteroids) and newer genetically-engineered medications.

When such conservative methods are no longer effective, or if extremities' functions decrease, surgery may become an option. The goal of the present invention in such cases is to prevent the need for surgery.

Most patients have improvement following surgery, but recovery may be gradual. Three powerful hydraulic factors underpin the effectiveness of post surgical treatment:

1—heat,

2—buoyancy, and

3—massage.

These create a relaxing and soothing experience, which relives pain thereby, improves the quality of life.

Immersion of hands, wrists, elbows, knees, and/or feet in hot fluid raises the body temperature in a focused and isolated fashion causing the blood vessels to dilate, increasing blood circulation in immersed area. Better blood circulation has a known healing power hence the existence of anti-inflammatory medication including Aspirin. The buoyancy of the fluid reduces weight by approximately 90%, which relieves pressure on joints and muscles and creates the relaxing sensation of weightlessness and eases impaired movement.

The massaging action of the present invention is created by sending a mixture of warm fluid and air through jet nozzles. This “energized” stream of fluid loosens tight muscles and stimulates the release of endorphins, the body's natural pain killers.

What is claimed is:

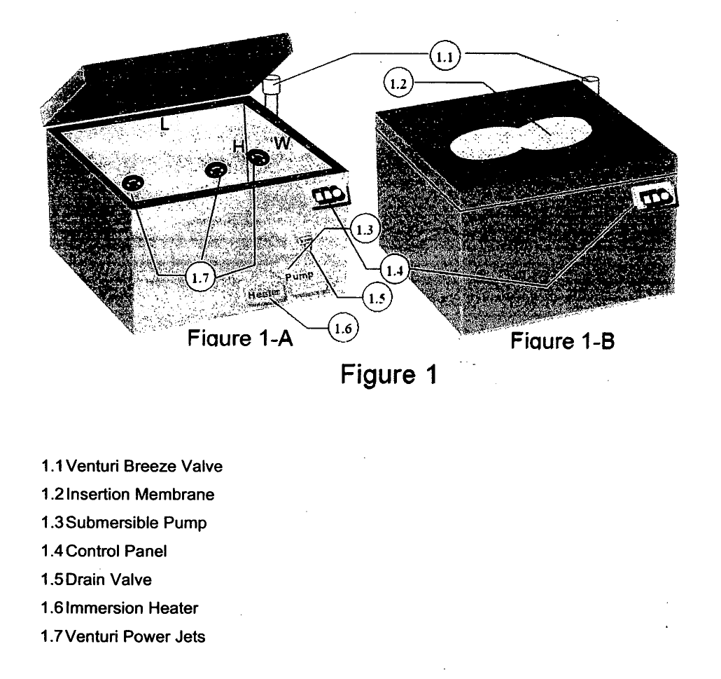

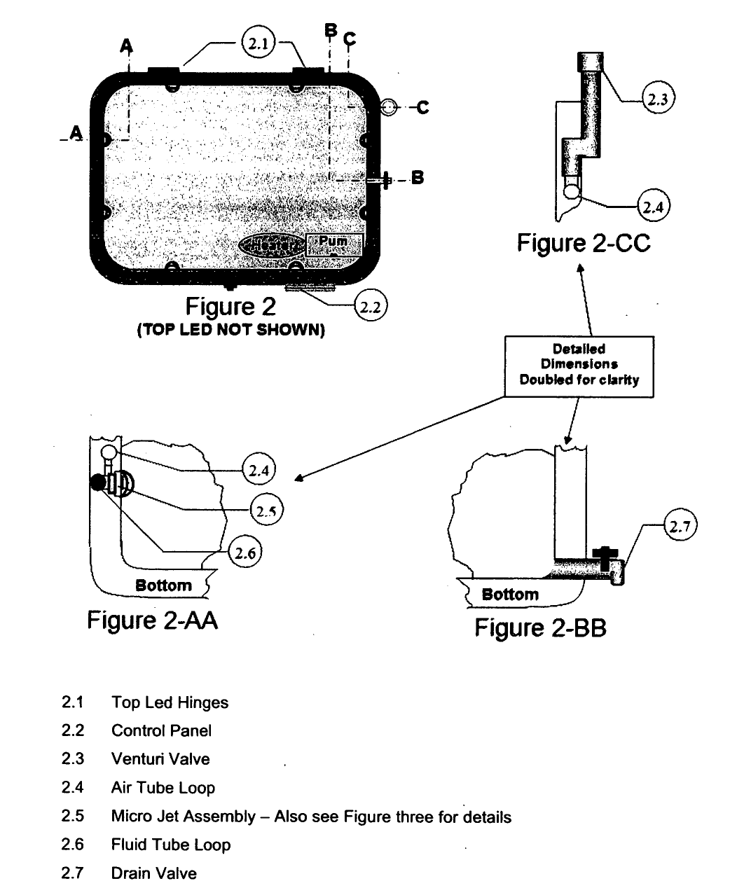

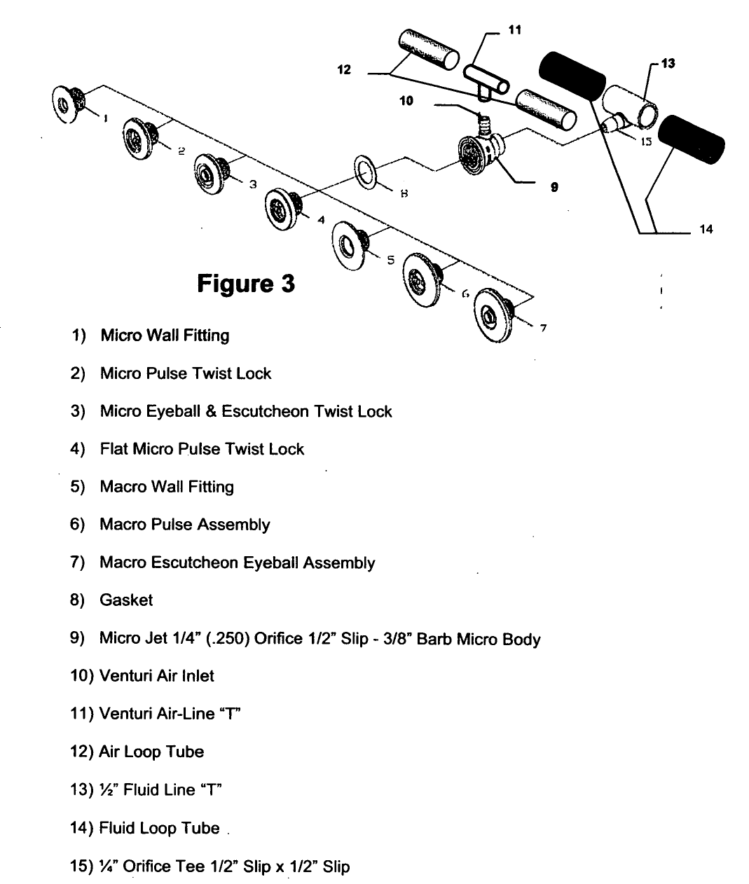

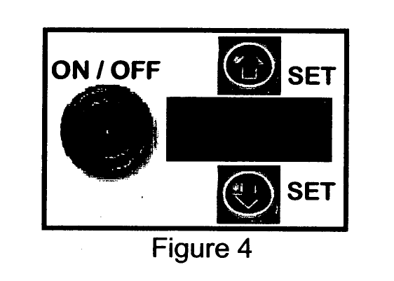

1) A Hydrotherapy, Thermotherapy, Homotherapy Apparatus for use by an individual to massage single extremity.
An apparatus consisting of a vessel that will hold mediums such as tab water, heavy or sea/salt water, and/or light mineral oil. The vessel can accommodate a person's extremities such as; a) wrist, hand, and fingers, b) elbow, c) ankle, foot, and toes, and/or d) knee, through a membrane orifice mounted on the top led (see FIG. 1) that surrounds and hugs the extremity at the point of entry therewith preventing the medium from splashing out of vessel while the apparatus is under its intended use. The operator may choose to bring the fluid medium content of the vessel to a pre-determined temperature with use of its control panel, thereby adding thermotherapy to the fluids buoyancy that has already eased movement and exercising of said submersed extremities. The present invention provides (depending on the applicable claim herewith that determines the size and utility of the vessel) a heat generating source that may be a Cartridge Heating Element, Tubular Heating Element, Flexible Heating Element, Band Heating Elements, Cable Heating Elements, or any other special heating element therewith stimulating the blood circulation and blood vessels and enhancing one's natural healing ability. The heating source may be immersion or inline type depending on the utilization of any of the claims established herewith. The present invention is further equipped with a submersible pump (see FIGS. 1 and 2) and a circuit of micro injector jets that mix the pumped medium with air through venturi function built-in the injector jets (see FIGS. 2 and 3) therewith adding the hydrotherapy or fluid-therapy as the case might be to the individuals use. This, the latter capability of the present invention adds the massaging function to the heat and buoyancy of the medium, which together with one's free movement exercise maximizes the post surgical, post injury, toning and shaping, post or pre sport event exercise benefits for the extremities. The vessel operation is managed through a built-in control panel that constantly monitors the vessel content temperature. The control (see FIG. 4) panel has two different models depending on required function. First, in case of inline heating source, once the operator sets the temperature (e.g., 104° F.) and toggle the ON button, the pump will start circulation; the heat sensor will communicate with the control panel as to the existing temperature. While the sensor reports temperature less than set point, the heating source will remain ON. Once the set point is reached, the heat source will only be turned ON by the control panel as to compensate for the heat loss during the operation. Once the user turns the unit OFF, the operation of the both the pump and the heat source will cease. Second, in the case of submersible heat source, upon user turning ON the apparatus, the heat source will elevate the temperature to bring the contentment to the desired set point. Assuming that the set point is established to be 104° F., the control panel will turn the pump on when a heat sensor reports a temperature of at least 10° F. less than the set point. This will provide for medium to be warmed up in absence of use by the operator but to become to its full function at a temperature still convenient for the user to use. Similarly, once the set point is reached, the heat source will only be turned ON by the control panel as to compensate for the heat loss during the operation. Once the user turns the unit OFF, the operation of the both the pump and the heat source will cease.

2) Apparatus as set forth in claim 1 which is further characterized by:
Its use by an individual for simultaneous submersion of; both wrists, hands, and fingers, or both ankles, feet, and toes, or one or both elbows, or one knee. The size of the vessel and the number, size and/or capacity of other accommodating parts including the pump, heating element, and micro injector jets are proportionately increased as to accommodate the proper functioning of the larger apparatus.

3) Apparatus as set forth in claim 1 which is further characterized by:
Its use in public spa and sport clubs as well as sport arenas and stadiums including enclosed boxing rings. The size of the vessel and the number, size and/or capacity of other accommodating parts including the pump, heating element, and micro injector jets are proportionately increased as to accommodate simultaneous use by two or more individuals who may be in facing, side by side, or sitting around the vessel position.

4) Apparatus as set forth in claim 1, 2, and 3 which is further to include: A three way drain valve that will either be in a position to circulate the vessel medium used in the apparatus as claimed under configurations 1, 2, and 3, or be set to a position that the pumping action will cause the medium be drained outside of the vessel. This shall make cleaning and maintenance easy on any and all prior claims.
